(19) United States
(12) Patent Application Publication
(10) Pub. No.: US 2007/0174097 A1
(43) Pub. Date: Jul. 26, 2007

(54) METHOD FOR COMPARING AVERAGE TRAVEL COSTS IN INTERSECTED MARKETS

(75) Inventor: Scott R. Gillespie, Solon, OH (US)

Correspondence Address: HAHN LOESER & PARKS, LLP, One GOJO Plaza, Suite 300, AKRON, OH, 44311-1076, US

(73) Assignee: TRX, INC., Atlanta, GA (US)

(21) Appl. No.: 11/622,889

(22) Filed: Jan. 12, 2007

Related U.S. Application Data
(60) Provisional application No. 60/758,513, filed on Jan. 12, 2006.

(51) Int. Cl. G06Q 10/00

(52) U.S. Cl. 705/5

(57) ABSTRACT

A method for comparing average travel costs in intersected markets is disclosed and comprises a method for measuring and comparing average costs incurred by buyers of travel, where the average cost of a specified supplier is derived from multiple markets, and the average cost from other suppliers is derived from the other suppliers' costs in the same markets as those used to derive the specified supplier's average costs.

### TECHNICAL FIELD

Embodiments of the present invention relate to accounting for travel costs, and enabling effective comparison between travel options. More particularly, embodiments of the present invention relate to a method for comparing average travel costs in intersected markets, for example, with respect to airlines, hotels, rental cars, or other travel-related businesses and the expenses associated with their use.

### BACKGROUND OF THE INVENTION

Corporations spend significant amounts of money on travel suppliers, such as airlines and hotels. Managers often seek reports that quantify the amount spent on airlines or hotels by supplier. For purposes of description, expenses associated with airline travel will be reviewed. Often these reports provide an average unit cost or price associated with each supplier, such as:

TABLE 1
Airline-level report

| Airline | Spend | Segments | Avg. Segment Price |
|---|---|---|---|
| AA | $250,000 | 500 | $500 |
| BA | $300,000 | 150 | $2,000 |

Table 1's data is typically obtained by summing all the spend and all the segments (or other similar units of volume) on each airline, and deriving an average unit cost for each supplier by dividing total spend by total units. The reader of this table will note a large differential in the average unit price between the two airline suppliers, but will not know if the two airlines compete in any, some or many common markets.

TABLE 2
City Pair-Airline report

| City Pair | Airline | Spend | Segments | Avg. Segment Price |
|---|---|---|---|---|
| NYCLON | AA | $100,000 | 40 | $2,500 |
| NYCLON | BA | $200,000 | 100 | $2,000 |

Table 2 shows the average cost by airline in each market, but because many companies buy airfares in hundreds or thousand of city pair markets, it is often not practical to use this level of detail to understand how much more cost effective one airline may be versus another.

It would be beneficial to have a method for comparing average costs between a specified travel expense, such as related to airline travel, such as for a predetermined airline, e.g., American Airlines, and the average costs paid to other airlines in the same markets used to report the American Airlines average price.

A report that compares a specified airline's average cost with the average costs of other airlines in the same markets would allow managers to more easily discern the general cost effectiveness of the specified airline. Similarly, such a tool would be beneficial for other travel related expenses, such as hotel, rental cars or the like.

Further limitations and disadvantages of conventional, traditional, and proposed approaches will become apparent to one of skill in the art, through comparison of such systems and methods with the present invention as set forth in the remainder of the present application with reference to the drawings.

### BRIEF SUMMARY OF THE INVENTION

A first embodiment of the present invention provides a method for comparing average travel costs in intersected markets.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a flow chart relating to an embodiment of the invention.

### DETAILED DESCRIPTION OF THE INVENTION

The description below is based on using airline data. One skilled in the art will understand how the methods and systems described herein could be easily converted and applied to hotel data, car rental data, or other travel-related data. The invention is therefore directed to a method and system wherein travel related expenses can be effectively compared and evaluated to facilitate making decisions on the use of travel related business and associated costs.

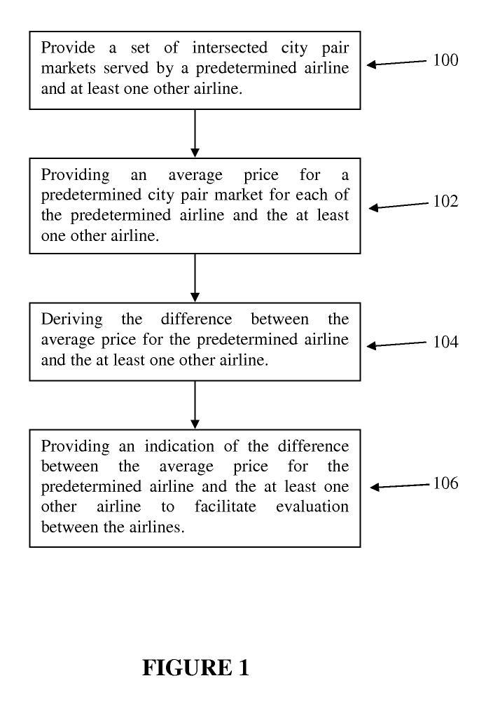

As shown in FIG. 1, the invention may be implemented via a method, which in turn may be implemented via software or in other suitable manners. A software program may provide an effective system for tracking and evaluating travel related expenses. The method may include a step at 100 of providing a set of intersected city pair markets, which are served by a predetermined travel related business, and at least one other related travel business, such as a predetermined airline and at least one other airline. An average price for a predetermined cit pair market is provided for each of the predetermined airline and the at least one airline at 102. Having this information, the difference between the average price for the predetermined airline and the at least one other airline is derived at 104. With this information, the system may provide an indication of the difference between the average price for the predetermined airline and the at least one other airline to evaluate travel expense alternatives for the set of intersected city pair markets at 106.

For a further understanding of the invention, the following example related to airline travel is set forth. As an example, raw travel data from a spend category, such as airlines (aka “air”) is assembled into a data table with the following structure as an example:

TABLE 3

| City Pair | Airline | Spend | Segments |
|---|---|---|---|
| NYCLON | AA | $100,000 | 40 |
| NYCLON | BA | $200,000 | 100 |
| ORDSFO | AA | $2,000 | 2 |
| ORDSFO | UA | $15,000 | 20 |
| CLEORD | AA | $50,000 | 100 |
| CLEORD | CO | $30,000 | 100 |
| CLEORD | UA | $20,000 | 75 |

In Table 3 above, if the Specified Airline is AA, then the NYCLON OA is BA; the ORDSFO OA is UA; and in CLEORD the OA is derived by combining the data from CO and UA.

In an embodiment, the user may set a minimum amount of air spend or air volume (e.g., segments) for preferably both the specified airline (SA) and the other airlines (OA). In Table 3 above, if the Specified Airline is AA, then the NYCLON OA is BA; the ORDSFO OA is UA; and in CLEORD the OA is derived by combining the data from CO and UA. These minimums will be used to determine the set of individual city pair markets which comprise the intersected set of markets.

A software program to implement the methods may find those city pairs where both conditions are true:
1. The spend or volume on the SA meets or exceeds the minimum, and
2. The spend or volume on the sum of all the OA's meets or exceeds the minimum.

These city pairs become the intersected set of markets for the Specified Airline (SA), and now must be further processed. Although the setting of minimums to arrive at the desired intersected set of city pair markets in this manner may be helpful to larger organizations with significant spending on travel related expenses, it should also be understood that it would be possible to implement the method without setting such minimums. In an example, assume the minimum is 10 segments for both the SA and OA for illustrative purposes below:

A new table is created with preferably the equivalent form of:

TABLE 4

| Intersected | Specified | SA's | SA's | SA's | OA's | OA's | OA's |
|---|---|---|---|---|---|---|---|
| City Pairs | Airline | Spend | Segs | ASP | Spend | Segs | ASP |
| NYCLON | AA | $100,000 | 40 | $2,500 | $200,000 | 100 | $2,000 |
| CLEORD | AA | $50,000 | 100 | $500 | $50,000 | 175 | $286 |
| Totals | AA | $150,000 | 140 | $1,071 | $250,000 | 275 | $909 |

The method, implemented via software for example, may then derive the Average Segment Price (ASP) in each row by dividing the row's spend by the row's segments (segs); once for the specified airline's data and once for the OA's data.

There are also several methods to weight the OA's average segment prices if desired. One possible method could use the SA's city pair's share of spend relative to the SA's total spend; while another method could use the SA's city pair's share of segments relative to the SA's total segments. Other methods of weighting the derived segment prices are contemplated. Such weighting again may be helpful under circumstances, but also may not be necessary to implementing the methods. The example below will use the share of SA's spend method to weight the OA's average segment prices.

1. Therefore, the method may be implemented, such as by software, to find the share of each intersected city pair's SA spend relative to the SA's total spend. Using the table above, the software derives the following table:

TABLE 5

| Intersected City Pair | Specified Airline | SA's Spend Share |
|---|---|---|
| NYCLON | AA | 67% |
| CLEORD | AA | 33% |

2. Each record may then be appended with a value that represents the difference, in this case the relative difference, in Average Segment Prices between the SA and the OA. Alternatively, the actual or absolute difference in average price could be determined. Using the data from Table 4 and a simple math operation produces:

TABLE 5a

| | | | OA's ASP is (Better) |
|---|---|---|---|
| | | | Worse Than SA's |
| Intersected City | Specified | SA's Spend | ASP by (as % of |
| Pair | Airline | Share | SA's ASP) |
| NYCLON | AA | 67% | (20%) |
| CLEORD | AA | 33% | (15%) |

3. The two numerical values in each record are multiplied together and then summed for the Specified Airline, and stored in a table, such as:

TABLE 5b

| | | OA's Weighted ASP |
|---|---|---|
| Intersected City Pair | Specified Airline | Differential |
| NYCLON | AA | (13%) |
| CLEORD | AA | (5%) |
| | Total Wtd. ASP Diff. | (18%) |

4. The SA's Average Segment Price for the set of intersected city pairs is combined with the Total Weighted ASP Differential value to produce the OA's Weighted Average Segment Price for the same set of intersected city pairs:

TABLE 6

| | SA's Average | | |
|---|---|---|---|
| | Segment Price | OA's Total | |
| Specified | for the Intersected | Wtd. ASP | OA's Wtd. ASP for the |
| Airline | City Pairs | Diff. | Intersected City Pairs |
| AA | $1,071 | (18%) | $878 |

The software repeats the steps above for a plurality of Specified Airlines. It may then produce a table of the equivalent form such as:

TABLE 7

| | | | OA's | SA's ASP |
|---|---|---|---|---|
| | SA's Average | | Wtd. ASP | is Better |
| | Segment Price | OA's | for the | (Worse) |
| Specified | for the Intersected | Total Wtd. | Intersected | than OA's |
| Airline | City Pairs | ASP Diff. | City Pairs | ASP by |
| AA | $1,071 | (18%) | $878 | ($193) |
| BA | $2,430 | 16% | $2,819 | $389 |
| CO | $438 | 5% | $460 | $22 |
| DL | $456 | (7%) | $424 | ($32) |

By multiplying the number of segments associated with each Specified Airline's Intersected City Pairs and the amount by which the SA's ASP is better or worse than the OA's ASP, a savings or loss can be calculated for each SA. The method or software may produce a table using the equivalent form of:

TABLE 8

| | | | Savings Gained |
|---|---|---|---|
| | SA's ASP | | Or (Lost) by |
| | is Better | SA's Segment | Using the SA |
| | (Worse) | Volume in | in the SA's |
| Specified | than OA's | Intersected | Intersected |
| Airline | ASP by | City Pairs | Markets |
| AA | ($193) | 140 | ($27,020) |
| BA | $389 | 125 | $48,625 |
| CO | $22 | 400 | $2,750 |
| DL | ($32) | 600 | ($19,200) |

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

What is claimed is:

1. A method for comparing the average purchase price or cost of air travel between a specified airline and a plurality of other airlines, comprising the steps of:
providing an intersected set of city pair markets, and wherein in each individual city pair market, a specified airline and other airlines provide service there between,
providing an average price for each individual city pair market for the specified airline and the other airlines,
deriving the difference between the average price for the specified airline and the other airlines and providing an indication of the difference.

2. The method of claim 1 wherein the average price of air travel on the specified airline and the other airlines is found for the set of the intersected city pair markets.

3. The method of claim 1, wherein the difference in average price is determined in either relative or absolute terms, and is found between the specified airline and a plurality of other airlines for each of the individual city pair markets comprising the set of intersected city pair markets.

4. The method of claim 1, further comprising the step of:
weighting the difference in average price of the other airlines on each individual city pair market relative to the proportion of the specified airline-city pair's share of the specified airline's total spend or volume across all of the individual city pair markets comprising the intersected city pair markets.

5. The method of claim 4, further comprising the step of:
summing the weighted price differentials of the other airlines on each of the individual markets and combining the sum with the specified airline's average price for the set of intersected city pairs to produce a weighted price associated with the plurality of other airlines for the set of intersected city pair markets.

6. The method of claim 1, wherein the intersected set of city pair markets is a group of at least five individual city pair markets.

7. The method of claim 1, wherein the average price or cost of air travel on the specified airline is found for the set of the intersected city pair markets, and the average price or cost of air travel on the plurality of other airlines is found for the set of the intersected city pair markets.

8. The method of claim 1, wherein the average price or cost of air travel on the specified airline is found for each of the individual city pair markets comprising the set of the intersected city pair markets, and the average price or cost of air travel on the plurality of other airlines is found for each of the individual city pair markets comprising the set of the intersected city pair markets.

9. The method of claim 1, wherein the average price or cost of air travel on the specified airline is found for each of the individual city pair markets comprising the set of the intersected city pair markets, and the average price or cost of air travel on the plurality of other airlines is found for each of the individual city pair markets comprising the set of the intersected city pair markets, and the difference in average price or cost is found between the specified airline and the plurality of other airlines for each of the individual city pair markets comprising the set of intersected city pair markets.

10. The method of claim 1, wherein the difference in average cost or price on each individual city pair market is weighted in a predetermined proportion to the specified airline-city pair's share of the specified airline's total spend or volume across all of the individual city pair markets comprising the intersected city pair markets.

11. The method of claim 10, wherein the sum of the weighted price or cost differentials from is combined with the specified airline's average price or cost for the set of intersected city pairs to produce a weighted price or cost associated with the plurality of other airlines for the set of intersected city pair markets.

12. A method of comparing the cost of travel related expenditures between a specified travel related business for which travel related expenses are incurred, and a plurality of other similar travel related business, comprising the steps of:
providing an intersected set of markets, where the intersected set of markets is a group of individual markets, and wherein in each individual market, there is a specified travel related business and a plurality of other similar travel related businesses,
providing an average price for each individual city pair market for the specified travel related business and the plurality of other travel related businesses,
deriving the difference between the average price for the specified travel related business and the other travel related businesses and providing an indication of the difference.

13. The method of claim 12 where the difference in average price is found in either relative or absolute terms.

14. The method of claim 12 where the travel related business is a specified hotel and the other travel related businesses are other hotels, and wherein an average price of a hotel stay or room night on the specified hotel is found for each of the individual markets within the set of intersected markets, and an average price or cost of a hotel stay or room night on a plurality of other hotels is found for each of the individual markets within the set of the intersected markets.

15. The method of claim 14 further comprising the step of:
weighting the difference in average price of the other hotels in each of the individual markets in proportion to the specified hotel-individual market's share of the specified hotel's total spend or volume across all intersected markets.

16. The method of claim 15, further comprising the step of
summing the weighted price differentials of the other hotels on each of the individual markets and combining the sum with the specified hotel's average price or cost for the set of intersected markets to produce a weighted price or cost associated with the plurality of other hotels for the set of intersected markets.

17. The method of claim 14 wherein the average price of expenses for the specified hotel and the other hotels are found for the set of the intersected city pair markets.

18. The method of claim 14, wherein the difference in average price is determined, and is found between the specified hotel and a plurality of other hotels for each of the individual city pair markets comprising the set of intersected city pair markets.

19. The method of claim 14, further comprising the step of:
weighting the difference in average price of the other hotels on each individual city pair market relative to the proportion of the specified hotel city pair's share of the specified hotel's total spend or volume across all of the individual city pair markets comprising the intersected city pair markets.

20. The method of claim 19, further comprising the step of:
summing the weighted price differentials of the other airlines on each of the individual markets and combining the sum with the specified hotel's average price for the set of intersected city pairs to produce a weighted price associated with the plurality of other hotels for the set of intersected city pair markets.

21. The method of claim 12, wherein the intersected set of city pair markets is a group of at least five individual city pair markets.

22. The method of claim 12, wherein the average price or cost of associated with the specified travel related business is found for the set of the intersected city pair markets, and the average price or cost of associated with the plurality of other travel related businesses is found for the set of the intersected city pair markets.

23. The method of claim 12, wherein the average price or cost associated with the specified travel related business is found for each of the individual city pair markets comprising the set of the intersected city pair markets, and the average price or cost associated with the plurality of other travel related businesses is found for each of the individual city pair markets comprising the set of the intersected city pair markets.

24. The method of claim 12, wherein the average price or cost associated with the specified travel related business is found for each of the individual city pair markets comprising the set of the intersected city pair markets, and the average price or cost associated with the plurality of other travel related businesses is found for each of the individual city pair markets comprising the set of the intersected city pair markets, and the difference in average price or cost is found between the specified travel related business and the plurality of other travel related businesses for each of the individual city pair markets comprising the set of intersected city pair markets.

25. The method of claim 12, wherein the difference in average cost or price on each individual city pair market is weighted in a predetermined proportion to the specified travel related business city pair's share of the specified travel related businesses total spend or volume across all of the individual city pair markets comprising the intersected city pair markets.

26. The method of claim 25, wherein the sum of the weighted price or cost differentials from is combined with the specified travel related business average price or cost for the set of intersected city pairs to produce a weighted price or cost associated with the plurality of other travel related businesses for the set of intersected city pair markets.

27. A method for comparing the average purchase price or cost of air travel between a specified airline and a plurality of other airlines in an intersected set of city pair markets, where the intersected set of city pair markets is a group of individual city pair markets, and where in each individual city pair market the buyer has purchased both a predetermined minimum amount of air travel on the specified airline, as well as a predetermined minimum amount of air travel on a plurality of other airlines,
providing an intersected set of city pair markets comprising at least five city pairs, where the intersected set of city pair markets is a group of at least five individual city pair markets, and wherein in each individual city pair market, a specified airline and other airlines provide service there between,
providing an average price for each individual city pair market for the specified airline and the other airlines,
deriving the difference between the average price for the specified airline and the other airlines and providing an indication of the difference.
